(19) United States
(12) Patent Application Publication
(10) Pub. No.: US 2021/0394666 A1
(43) Pub. Date: Dec. 23, 2021

(54) DEVICE FOR FIXING A CONTAINER ON THE LOADING AREA OF A VEHICLE

(71) Applicant: THE DYNAMIC ENGINEERING SOLUTION PTY LTD, Holden Hill, South Australia (AU)

(72) Inventors: Michael NEWSTEAD, Gawler (AU); James BROWNE, Woodville South (AU); Oscar FIORINOTTO, Semaphore Park (AU)

(73) Assignee: THE DYNAMIC ENGINEERING SOLUTION PTY LTD, Holden Hill, South Australia (AU)

(21) Appl. No.: 16/972,952

(22) PCT Filed: Jun. 5, 2019
(86) PCT No.: PCT/EP2019/064644

§ 371 Date: Dec. 7, 2020

(30) Foreign Application Priority Data
Jun. 8, 2018 (DE) 10 2018 113 778.8

(51) Int. Cl. B60P 7/13; B65D 90/00

(52) U.S. Cl. CPC B60P 7/132; B65D 90/0013

(57) ABSTRACT

The invention relates to a device (1) for fixing a container on a loading area, having a bolt (6) and having a lift drive (10), wherein the bolt (6) is rotatable and by means of the lift drive (10) is displaceable along a longitudinal axis of the bolt (6), wherein the bolt (6) in a secured position by means of a locking element (21) is secured against rotation and against axial displacement.

The device (1) for fixing the container is improved in that the lift drive (10) is designed in such a manner that a head (7) of the bolt is displaceable through the slot (5) up to a first terminal position, wherein the head (7) of the bolt (6) in the first terminal position is spaced apart from the periphery of the slot (5) so as to have an axial clearance relative to said periphery, wherein the bolt (6) then is retractable to a second terminal position in which the head (7) of the bolt (6) bears on the periphery of the slot (5).

The invention relates to a device for fixing a container on the loading area of a vehicle, according to the features of the preamble of Patent Claim 1.

Such devices are also referred to as twist locks. The device has a bolt having a mushroom-type head, said bolt being displaceable about the longitudinal axis thereof. Furthermore, the bolt is rotatable. To this end, an ISO container has a container casting in the form of a corner fitting. The container casting has an opening in the form of a slot. The bolt, after having been pushed into the slot of the container casting from below and after having subsequently been rotated, by way of the mushroom-type head of said bolt engages behind the peripheries of the slot and thus fixes the container casting and thus the container on the loading area. The bolt is rotatable and by means of a lift drive is capable of being raised along the longitudinal axis of said bolt.

As per the generic publication EP 2 159 101 A1, the bolt in a secured position is now secured by means of a blocking means against rotation and against axial displacement. To this end, the bolt has a through opening that extends transversely to the longitudinal axis of said bolt. The through opening on that side thereof that faces away from the head is configured so as to have a ramp. A locking element or blocking means is configured as a locking wedge which is capable of being pushed into the through opening. The locking wedge herein is activatable by means of a hydraulic cylinder. A rotary cylinder is provided as a rotary drive. The bolt herein is urged to the deployed position thereof by the force of a spring. Said spring serves as the lift drive.

This generic prior art has the disadvantage that the axial movement of the bolt cannot be controlled in an optimal manner. The bolt is indeed drawn towards the peripheries of the slot by the locking wedge, however it is not ensured that the bolt is rotatable in the event of sub-optimal positioning of the container casting. It can arise that the mushroom-type head of the bolt is deployed only up to the height of the slot and thus in the event of a rotation impact on the internal wall of the slot, the secured position thus not being reached.

A further twist lock is known from U.S. Pat. No. 5,927,916, wherein the twist lock is automated and is thus activatable by remote control. To this end, a piston/cylinder assembly is disposed as a lift drive below the loading area, said piston/cylinder assembly displacing the bolt along the longitudinal axis thereof, that is to say in a substantially vertical manner. A motor is provided in order for the bolt to be rotated. Said motor serves as the rotary drive.

The invention is based on the object of improving the device for fixing the container.

This object on which the invention is based is now achieved by a device having the features of Patent Claim 1 and by a method having the features of Patent Claim 9.

According to the invention, the lift drive is designed in such a manner that a head of the bolt is displaceable through the slot up to a first terminal position, wherein the head of the bolt in the first terminal position is spaced apart from the periphery of the slot so as to have an axial clearance relative to said periphery, wherein the bolt then is retractable to a second terminal position in which the head of the bolt bears on the periphery of the slot.

The method is distinguished in that a head of the bolt is displaced through the slot up to a first terminal position, wherein the head of the bolt in the first terminal position is spaced apart from the periphery of the slot so as to have an axial clearance relative to said periphery, wherein the bolt then is retracted to a second terminal position in which the head of the bolt bears on the periphery of the slot.

The bolt herein in the longitudinal direction is deployed further than would be necessary in principle, specifically such that an axial clearance remains between the upper peripheries of the slot and the lower side of the head of the bolt. This ensures that the bolt can be reliably rotated without impacting on the internal wall of the slot. The bolt, when rotated or after having been rotated, is retracted and by way of the head of said bolt bears on the peripheries of the slot.

Said clearance, that is to say the axial spacing of the lower side of the head from the upper side of the base of the container casting, is preferably more than 0.5 times the axial thickness of the head. Said axial clearance can in particular correspond substantially to the axial thickness of the head.

The lift drive has a cylinder and a piston, wherein the bolt is displaceable by displacing the piston. The lift drive is preferably hydraulically activatable. Alternatively, the lift drive can be activatable in a pneumatic or motorized manner, for example by means of a rack or a worm drive. The lift drive is in particular configured as a pneumatically or hydraulically activatable cylinder. A corresponding piston is disposed so as to be displaceable within the cylinder, wherein the piston interacts indirectly or directly with the bolt.

The locking element is displaceable by a cylinder/piston assembly. The cylinder assembly is preferably hydraulically activatable. Alternatively, the locking element can be driven in a pneumatic or motorized manner, for example by means of a rack. After reaching the second terminal position, the locking element is pushed into a through opening in the bolt. The through opening can be configured as a bore and extends transversely, preferably perpendicularly, to the longitudinal axis of the shank of the bolt.

The bolt on the circumference preferably has a control curve, wherein a rotatable control cam engages in the control curve, wherein the bolt is rotatable about the longitudinal axis thereof by rotating the control cam. The rotation axis of the control cam is in particular disposed so as to be orthogonal to the longitudinal axis of the bolt. Alternatively, the control cam can also be driven by a rotary drive, in particular a motor. The motor can operate hydraulically, pneumatically, or electrically.

A gradient of the control curve and/or the shape of the control cam can vary in such a manner that the rotating speed of the bolt is not in proportion to the rotating speed of the control cam. This has the advantage that the bolt attains a higher acceleration when said bolt has reached the completely deployed position, for example, and the rotating movement can be completed already prior to the head bearing on the upper side of the peripheries of the slot.

Alternatively, the rotary drive can also be formed by a gear rim on the bolt, or on a component that is connected in a rotationally fixed manner to the bolt, and by a motorized drive of the gear rim.

The device is capable of being remote-controlled from the cab of the vehicle. On account thereof, the operator need not leave the cab in order for the container to be secured by means of the devices.

There are now a multiplicity of possibilities for designing and refining the invention. To this end, reference may first be made to the patent claims dependent on Patent Claim 1. A preferred design embodiment of the invention will be explained hereunder by means of the drawing and the associated description. In the drawing:

FIG. 1 in a schematic sectional illustration shows a device for fixing a container on a loading area of a vehicle, having a container casting, wherein a bolt is disposed in a lower position;

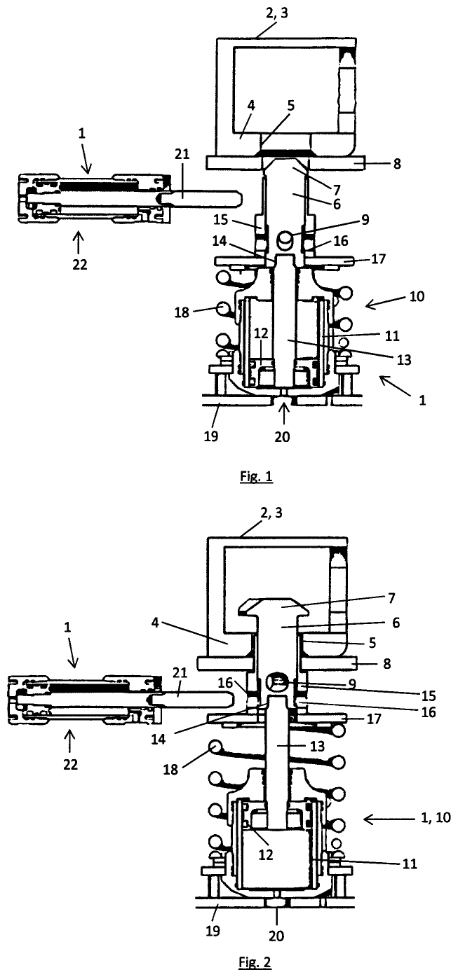

FIG. 2 in a schematic sectional illustration shows the device of the container casting, wherein the bolt is disposed in an upper first terminal position in which the bolt engages in the container casting;

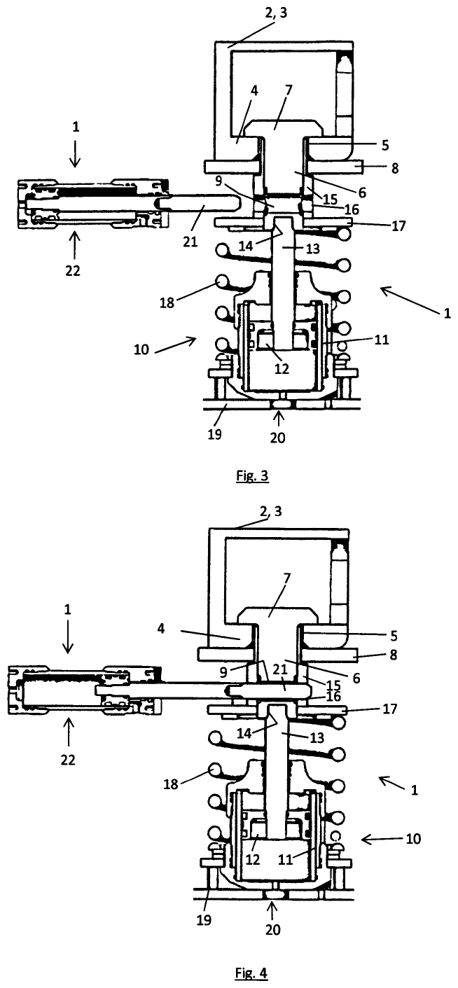

FIG. 3 in a schematic sectional illustration shows the device and the container casting, wherein the bolt now is disposed in a second terminal position in which said bolt bears on the base of the container casting, but a locking element is not yet disposed in a blocked position; and

FIG. 4 in a schematic sectional illustration shows the device of the container casting, wherein the bolt is disposed in the position of FIG. 3 and the locking element is now disposed in the blocked position.

FIGS. 1 to 4 are now discussed in more detail hereunder.

A device 1 for fixing a container on the loading area of a vehicle (not illustrated in more detail) can be readily seen in FIGS. 1 to 4. These devices 1 are also referred to as twist locks. Only a corner fitting of the container, specifically a so-called container casting 2, is illustrated. The container casting 2 is formed by a housing 3, wherein the housing 3 on the base 4 thereof has a slot 5.

The device 1 now has a bolt 6, wherein the bolt 6 has a head 7. As can be readily seen in FIGS. 1, 2, and 3, the head 7 herein is not configured so as to be rotationally symmetrical, but is rectangular, for example. The head 7 in the position illustrated in FIG. 1 is oriented in such a manner that the head 7 by way of a movement along the longitudinal axis (not referred to in more detail) of the bolt 6 can be pushed through the slot 5. By subsequently rotating the bolt 6, the head 7 can be brought to bear on the peripheries (not referred to in more detail) of the slot 5 (cf. FIGS. 3 and 4) such that the container casting 2 can be brought to bear tightly on a base plate 8 of the device 1. The base plate 8 can form part of the loading area of the vehicle. The bolt 6, after having been pushed into the slot 5 of the container casting 2 from below and after having subsequently been rotated, by way of the mushroom-type head 7 of said bolt 6 engages behind the peripheries of the slot 5 and thus fixes the container casting 2 and thus the container on the loading area.

The bolt 6 in the region of the shank thereof (not referred to in more detail) has a through hole 9. The through hole 9 extends transversely to the longitudinal axis of the bolt 6. The through hole 9 extends so as to be substantially perpendicular to the longitudinal axis of the bolt 6.

The bolt 6 is displaceable along the longitudinal axis thereof by means of a lift drive 10. The lift drive 10 has a cylinder 11 and a piston 12 that is guided in the cylinder 11. The piston 12 by way of seal rings (not referred to in more detail) is guided on the internal wall of the cylinder 11. The piston 12 supports a plunger 13 which engages in a receptacle 14 in the base of the bolt 6.

The bolt 6 is disposed so as to be rotatable within a sleeve 15, wherein the sleeve 15 has at least one, in particular two, penetration openings 16. The penetration opening 16 in terms of height is level with the through hole 9 of the bolt 6, wherein the penetration opening 16 in the second terminal position of the bolt 6 illustrated in FIGS. 3 and 4 is disposed so as to be in alignment with the through hole 9.

The sleeve 15 has a collar 17, wherein a spring 18 is disposed below the collar 17, wherein said spring 18 encompasses the cylinder 11. The spring 18 herein is supported on the collar 17, on the one hand, and on a base region 19, on the other hand. The base region 19 has a connector 20 which opens into the interior space of the cylinder 11. A respective hydraulic means can be directed into the cylinder 11 or be retrieved from the cylinder 11 by way of said connector 20.

The through hole 9 and the penetration opening 16 of the sleeve 15 in the second terminal position can be penetrated by means of a locking element 21, on account of which the bolt 6 is axially fixed, on the one hand, and a rotation of the bolt 6 is prevented, on the other hand. A secured position or a blocked position is achieved on account thereof.

The locking element 21 is displaceable by means of a cylinder/piston assembly 22. The cylinder/piston assembly 22 can be hydraulically or pneumatically activatable. Alternatively, the locking element 21 can be displaced by a motor having a rack or a worm drive.

The automated method for activating the device 1 is carried out as follows.

The bolt 6 from the initial position illustrated in FIG. 1 is first displaced in the axial direction in an upward manner until the head 7 of said bolt 6 has passed the slot 5. The head 7 herein is displaced and rotated so far upwards to a first terminal position such that a clearance remains between the head 7 and the upper side of the slot 5, as is illustrated in FIG. 2. This clearance, that is to say the axial spacing of the lower side of the head 7 from the upper side of the base 4, is preferably more than 0.5 times the axial thickness of the head 7. Said axial clearance can in particular correspond substantially to the axial thickness of the head 7. Thereafter, the bolt 6 can be retracted to the second terminal position (cf. FIG. 3). The penetration opening 16 and the through hole 9 in the second terminal position are now disposed so as to be in alignment such that the locking element 21 is capable of being pushed through the through hole 9 and the penetration opening 16. On account thereof, the bolt 6 in the secured position is secured against rotation and against axial displacement.

### LIST OF REFERENCE SIGNS

1 Device for fixing a container/Twist lock

2 Container casting

3 Housing

4 Base

5 Slot

6 Bolt

7 Head

8 Base plate

9 Through opening

10 Lift drive

11 Cylinder

12 Piston

13 Plunger

14 Receptacle in the base of the bolt

15 Sleeve

16 Penetration opening in the sleeve

17 Collar of the sleeve

18 Spring

19 Base region

20 Connector

21 Locking element

22 Cylinder/piston assembly

1. Device (1) for fixing a container on a loading area, having a bolt (6) and having a lift drive (10), wherein the bolt (6) is rotatable and by means of the lift drive (10) is displaceable along a longitudinal axis of the bolt (6), wherein the bolt (6) in a secured position by means of a locking element (21) is secured against rotation and against axial displacement, characterized in that the lift drive (10) is designed in such a manner that a head (7) of the bolt is displaceable through the slot (5) up to a first terminal position, wherein the head (7) of the bolt (6) in the first terminal position is spaced apart from the periphery of the slot (5) so as to have an axial clearance relative to said periphery, wherein the bolt (6) then is retractable to a second terminal position in which the head (7) of the bolt (6) bears on the periphery of the slot (5).

2. Device according to the preceding claim, characterized in that the clearance is more than 0.5 times the axial thickness of the head (7).

3. Device according to one of the preceding claims, characterized in that the lift drive (10) has a cylinder (11) and a piston (12) wherein the bolt (6) is displaceable by displacing the piston (12).

4. Device according to one of the preceding claims, characterized in that the lift drive (10) is hydraulically activatable.

5. Device according to one of the preceding claims, characterized in that the locking element (21) by way of a cylinder/piston assembly (22) is displaceable through a through opening (9) of the bolt (6).

6. Device according to one of the preceding claims, characterized in that the cylinder/piston assembly (22) is hydraulically activatable.

7. Device according to one of the preceding claims, characterized in that the bolt (6) on the circumference thereof has a control curve, wherein a rotatable control cam engages in the control curve, wherein the bolt (6) is rotatable about the longitudinal axis thereof by rotating the control cam.

8. Device according to one of the preceding claims, characterized in that the control cam is capable of being driven, or is driven, respectively, by a rotary drive, in particular a motor.

9. Device according to one of the preceding claims, characterized in that a gradient of the control curve and/or the shape of the control cam vary/varies in such a manner that the rotating speed of the bolt (6) is not in proportion to the rotating speed of the control cam.

10. Method for operating a device (1) for fixing a container on a loading area, according to one of the preceding claims, wherein the bolt (6) is rotated and by means of the lift drive (10) is displaced along the longitudinal axis of the bolt (6), wherein the bolt (6) in a secured position by means of a locking element (21) is secured against rotation and against axial displacement, characterized in that a head (7) of the bolt is displaced through the slot (5) up to a first terminal position, wherein the head (7) of the bolt (6) in the first terminal position is spaced apart from the periphery of the slot (5) so as to have an axial clearance relative to said periphery, wherein the bolt (6) then is retracted to a second terminal position in which the head (7) of the bolt (6) bears on the periphery of the slot (5).
